(19) United States
(12) Patent Application Publication
(10) Pub. No.: US 2026/0294154 A1
(43) Pub. Date: Oct. 1, 2026

(54) HOUSEHOLD COOKING UTENSILS

(71) Applicant: COODAL INC., Incheon (KR)

(72) Inventors: Byoungho SON, Incheon (KR); Chiyoung SON, Busan (KR)

(73) Assignee: COODAL INC., Incheon (KR)

(21) Appl. No.: 19/478,912

(22) PCT Filed: Jan. 19, 2024
(86) PCT No.: PCT/KR2024/001003

§ 371 Date: Oct. 27, 2025

(30) Foreign Application Priority Data
Apr. 27, 2023 (KR) 10-2023-0055764

(51) Int. Cl. A47J 27/00; A23B 4/052; A47J 36/08; A47J 36/38

(52) U.S. Cl. CPC A47J 27/002; A23B 4/052; A47J 36/08; A47J 36/38

(57) ABSTRACT

Household cooking utensils according to an embodiment of the present invention comprise: a lower container directly heated by a lower heating medium; and an upper container that accommodates therein a dish to be prepared and is placed on the upper end of the lower container and provides a cooking space so that air heated in the lower container raises the internal temperature of the dish to be prepared; and a lid that covers the upper container so that the dish to be prepared is not exposed to the outside. The upper container includes: a cooking plate on which the dish to be prepared is placed; and a heat inlet part located at the center of the cooking plate and configured to discharge, along the surface of the cooking plate, the heated air that flows in from the lower container.

### TECHNICAL FIELD

The present invention relates to household cookware, more particularly to household cookware with indirect heating that is capable of cooking a dish to be prepared by means of indirect heat in which far infrared rays are contained.

### BACKGROUND ART

Generally, cookware is a tool for cooking in terms of definition and includes large-sized devices, cooking tools, kitchen utensils, etc. A material, a structure, and performance of the cookware has influences on cooking efficiencies, shapes of dishes, feasibility of food ingredients or heat sources, sanitation, etc., and the cookware is diversely classified into home use cooking and large amount cooking, Korean, Japanese, China and Western cooking methods, cooking types, etc. Further, the cookware is used for multi-purposes or used within a narrow range, and there is cookware that can be used for multi-purposes through replacement of components. Furthermore, the cookware includes rice pots, steamers, grillers, different types of pots, etc.

One of conventional cookware, that is, cookware using far infrared emitting materials (hereinafter referred to as conventional cookware) is suggested in Korean Patent No. 10-2142110. The conventional cookware includes: a base body heated directly by a heating medium; a cooking plate convex at the central portion thereof and low in height toward the periphery thereof in such a way as to be seated on a seating portion of the base body and having a plurality of heating holes thereon to allow heat to move up and down; a circular oil collection groove formed along the periphery of the base body to collect the oil discharged from a dish to be prepared thereto through the cooking plate; and liquid or powder type far infrared emitting materials received inside a heating portion of the base body to emit far infrared rays to the cooking plate when heated by the heating medium so that the dish to be prepared is heated indirectly to allow the far infrared rays to permeate into the dish to be prepared.

According to the conventional cookware, however, oils generated from the dish to be prepared are dropped to the base body or heating medium by means of the plurality of heating holes adapted to allow the far infrared rays to permeate into the dish to be prepared, thereby generating smoke. As the heat generated from the heating medium and the far infrared rays directly permeate into the dish to be prepared by means of the plurality of heating holes, further, the bottom of the dish is more quickly cooked than the top thereof so that undesirably, the dish to be prepared has to be overturned periodically by a user.

Besides, the conventional cookware is provided with the circular oil collection groove that is formed along the periphery of the base body so that since the circular oil collection groove is not separable from the base body, it is inconvenient to wash it. Most of oils discharged from the dish to be prepared are collected to the circular oil collection groove, and after used, therefore, it should be washed. To wash the circular oil collection groove, however, the far infrared emitting materials have to be inconveniently removed from the interior of the base body connected physically to the circular oil collection groove.

### DISCLOSURE

### Technical Problem

Accordingly, the present invention has been made in view of the above-mentioned problems occurring in the related art, and it is an object of the present invention to provide household cookware that is capable of preventing smoke from being generated due to oils discharged from a dish to be prepared and allowing the dish to be prepared to be cooked evenly, without turning the dish upside down.

### Technical Solution

To accomplish the above-mentioned object, according to an embodiment of the present invention, household cookware may include: a lower container directly heated by a heating medium located therebelow; an upper container seated on top of the lower container in such a way as to receive a dish to be prepared therein to provide a cooking space in which an internal temperature of the dish to be prepared increases by means of air heated in the lower container; and a lid for covering the upper container so that the dish to be prepared is not exposed to the outside, wherein the upper container may include: a cooking plate on which the dish to be prepared is placed; a heat inlet part located at the center of the cooking plate in such a way as to emit, along the surface of the cooking plate, the heated air that flows in from the lower container; a discharge groove located at the periphery of the cooking plate in such a way as to collect materials discharged from the dish to be prepared along a downward slope of the cooking plate; and a wing connected to the discharge groove in such a way as to seat the periphery of the lid thereon to fix the lid thereto.

According to the embodiment of the present invention, the heat inlet part may include: an exhauster having a plurality of inlet holes into which the air heated in the lower container is introduced; a cap provided to form an exhaust path of the heated air, while covering the exhauster; and a fastener for connecting centers of the exhauster and the cap.

According to the embodiment of the present invention, the exhauster may include: a first bent portion having the shape of a loop surrounding the outer periphery of the exhauster to provide a first stepped portion; a second bent portion having the shape of a loop with a shorter diameter than the first bent portion to provide a second stepped portion; a first connection portion connecting the first bent portion and the second bent portion to each other and having the plurality of inlet holes thereon; and a second connection portion connecting an interior of the second bent portion and having a first through hole at the center thereof to pass the fastener therethrough.

According to the embodiment of the present invention, the cap may include: a circular plate having a second through hole at the center thereof to pass the fastener therethrough; and a leg extending downward from the periphery of the circular plate in such a way as to surround the first bent portion.

According to the embodiment of the present invention, the leg may have a plurality of convex portions and a plurality of concave portions arranged alternately with one another.

According to the embodiment of the present invention, the exhaust path may be formed by means of a gap between the concave portions and the exhauster.

According to the embodiment of the present invention, the discharge groove may have discharge holes adapted to discharge the materials discharged from the dish to be prepared to the outside of the upper container.

According to the embodiment of the present invention, the lower container may include: a heating portion protruding downward therefrom in such a way as to come into contact with the heating medium and receiving far-infrared emitters therein to emit far-infrared rays when heated; a smoking portion extending outward from top of the heating portion in such a way as to place a smoking generator on top thereof; and a seating portion extending outward from the periphery of the smoking portion in such a way as to come into contact with a portion of the underside of the upper container to seat the upper container thereon.

According to the embodiment of the present invention, the lower container may further include a slope portion between the smoking portion and the seating portion to provide a stepped portion therebetween.

### Advantageous Effects of Invention

According to the embodiment of the present invention, the household cookware is configured to have the cooking plate provided with the heat inlet part so that while the oils discharged from the dish to be prepared are being not dropped to the lower container, the heat generated from the heating medium is effectively diffused to the upper container. As a result, the indirect heating cooking is allowed at home, and without turning the dish upside down in the upper container, the dish to be prepared can be evenly cooked within a short time. Further, the lower container is provided with the smoking portion so that smoked dishes can be prepared effectively even with at least amount of smoke generator.

According to the embodiment of the present invention, in addition, the household cookware is configured to physically distinguish the upper container coming into contact with the materials (e.g., oils) discharged from the dish to be prepared from the lower container coming into no contact with the oils from each other so that the materials are discharged from the upper container to the outside, without flowing into the lower container, thereby being easy in washing and enabling the far infrared emitting materials located in the lower container to be semi-permanently reused, without having any separate washing.

### BRIEF DESCRIPTION OF DRAWINGS

FIGS. 1 to 3 show household cookware according to an embodiment of the present invention.

FIG. 4 is an exploded perspective views showing the household cookware according to the embodiment of the present invention.

FIG. 5 is a sectional view showing a lower container of FIG. 4.

FIGS. 6 and 7 are perspective views showing an upper container of FIG. 4.

FIG. 8 is a sectional view showing the household cookware of FIG. 2.

FIG. 9 is an exploded view showing a heat inlet part of FIG. 8.

FIG. 10 is a bottom view showing a cap of FIG. 9.

FIG. 11 is a sectional view showing the flow of air through the heat inlet part of FIG. 8.

### MODE FOR INVENTION

An embodiment of the present invention will be described in detail with reference to the attached drawings so that it may be carried out easily by those having ordinary skill in the art. An explanation of the present invention is given for merely functional embodiments, and therefore, the scope of the present invention is not interpreted as limited by the embodiment of the present invention. The disclosed embodiments are merely exemplary of the invention, which can be embodied in various forms.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

Terms, such as the first, the second, and the like may be used to describe various elements, but the elements should not be restricted by the terms. The terms are used to only distinguish one element from the other element. For example, a first element may be named a second element without departing from the scope of the present invention.

Hereinafter, an embodiment of the present invention will be described with reference to the attached drawings.

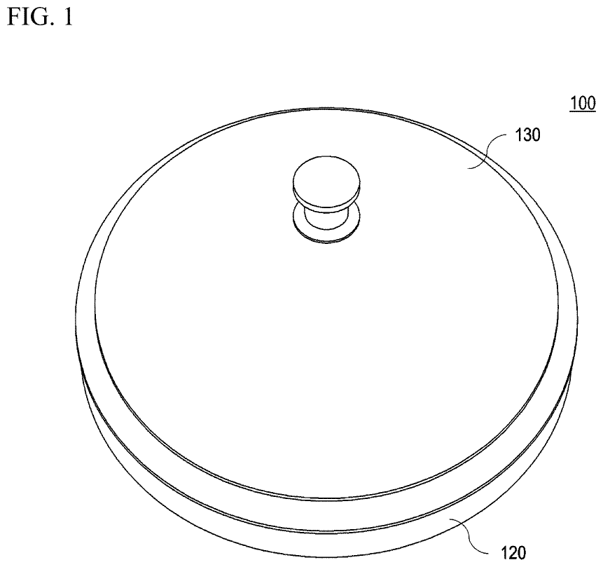

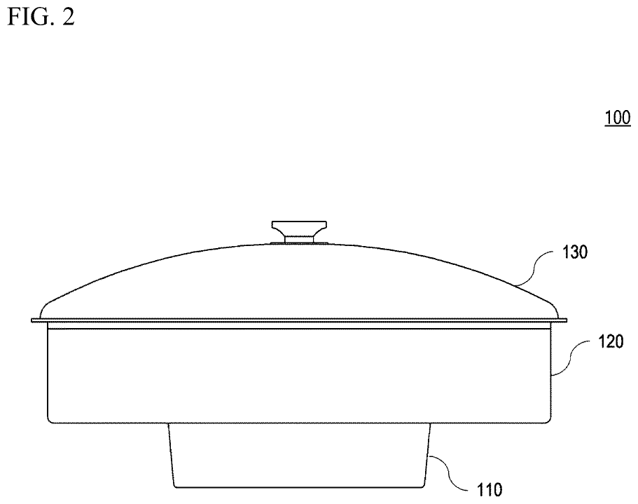

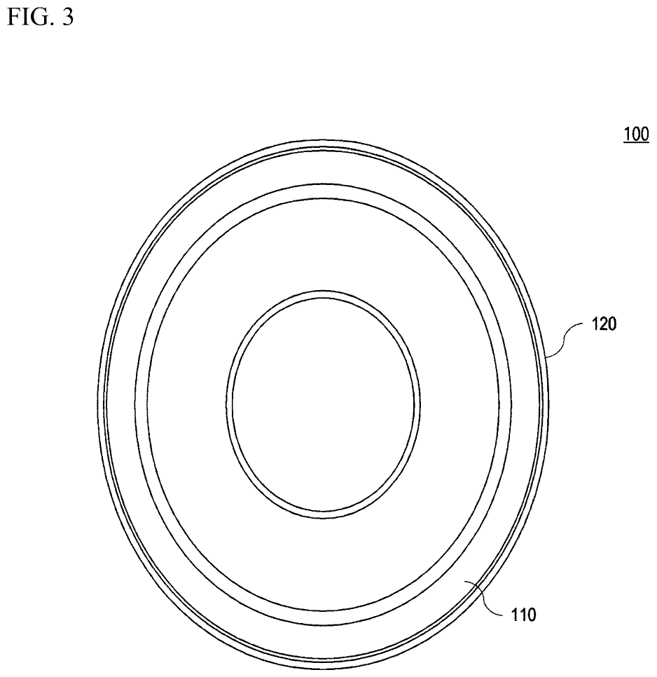

FIGS. 1 to 3 show household cookware according to an embodiment of the present invention. FIG. 1 is a perspective view showing household cookware 100 according to the embodiment of the present invention, FIG. 2 is a front or side view showing the household cookware 100, and FIG. 3 is a bottom view showing the household cookware 100.

The household cookware 100 according to the embodiment of the present invention includes a lower container 110, an upper container 120, and a lid 130. The household cookware 100 is a cooking tool with indirect heating that is used at home. Indirect heating cooking allows a dish to be prepared to be cooked with indirect heat using a medium such as air, water, or another material, without having any physical contact between the dish and a heating medium.

The household cookware 100 is configured to allow the lower container 110 to directly receive heat from a heating medium, to transfer the heat generated therein to the upper container 120 through a medium received in the lower container 110, and finally cook a dish to be prepared located in the upper container 120. Further, the lid 130 serves to minimize the emission of the heat transferred to the upper container 120 and thus to keep an internal temperature of the upper container 120 to a given temperature or more.

According to the embodiment of the present invention, the lower container 110 receives a far-infrared emitter therein. The far-infrared emitter is a material that emits far-infrared rays. For example, the far-infrared emitter is one of yellow earth, charcoal, tourmaline, germanium, barley stone, and ceramic, a combination of two or more materials thereof, or a composition made by mixing herbal medicine powder or herbal medicine decoction with one or combination.

As a result, the household cookware 100 emits a large amount of far-infrared rays when heated and thus allows the emitted far-infrared rays to permeate deeply into the dish to be prepared, thereby heating the dish to be prepared quickly and evenly. Further, the household cookware 100 prevents the smell of the dish to be prepared from being generated through the emission of the far-infrared rays and improves the taste and flavor of the dish, without allowing the dish to be burnt, while high fat oils of the dish are being discharged therefrom.

For the convenience of explanation, hereinafter, the household cookware 100 prepares, for example, a grilled dish. However, it is to be understood by a person having the skill in the art that the household cookware 100 is easily used to prepare a steamed dish, steamed rice, and the like, without being used only for the grilled dish.

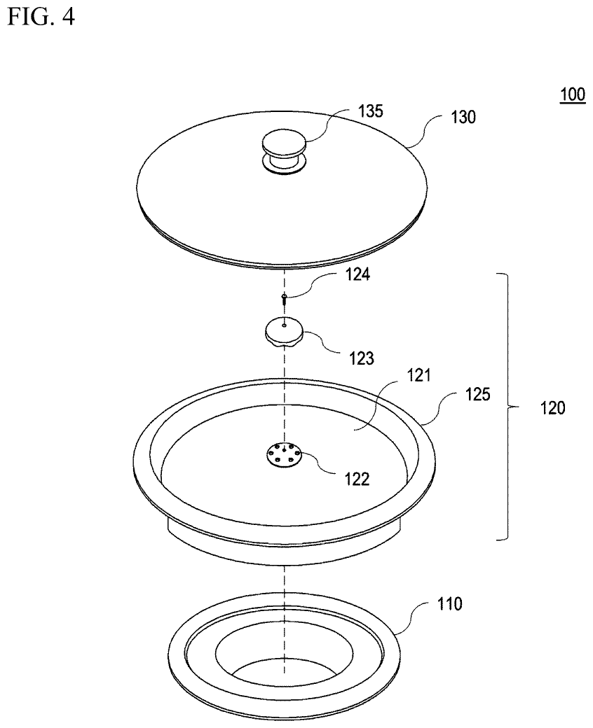

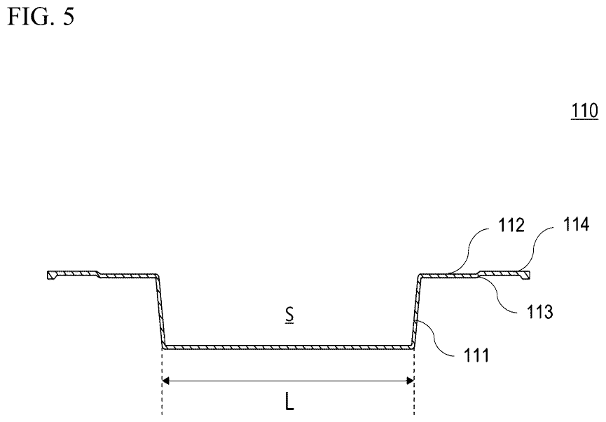

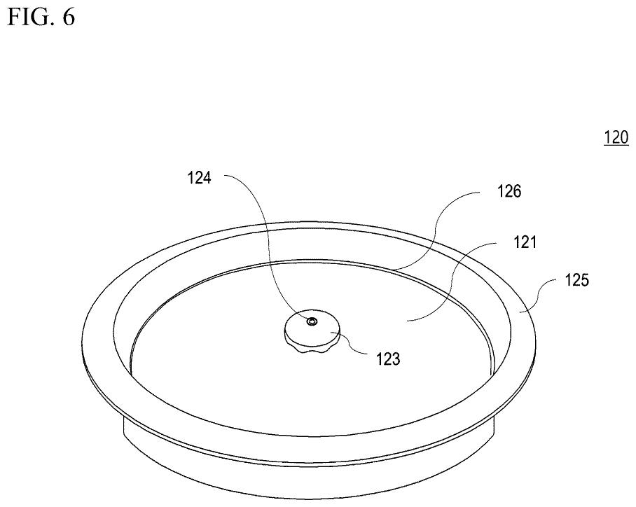

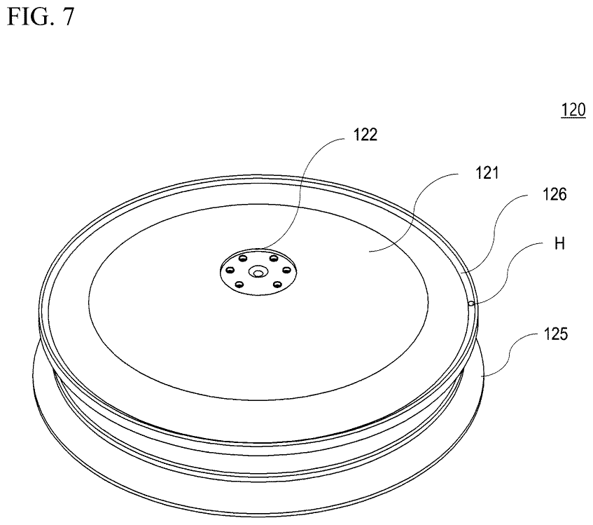

FIG. 4 is an exploded perspective views showing the household cookware according to the embodiment of the present invention, FIG. 5 is a sectional view showing the lower container of FIG. 4, and FIGS. 6 and 7 are perspective views showing the upper container of FIG. 4. Referring to FIGS. 4 to 7, the household cookware 100 is configured to allow the lower container 110, the upper container 120, and the lid 130 to be laminated on top of one another in the order mentioned.

The lower container 110 is heated directly by a heating medium located therebelow. Even though the heating medium is not shown, it includes a cooktop for home use. For example, the heating medium includes a stove top, a highlight cooktop, an induction cooktop, etc. The lower container 110 consists of a heating portion 111, a smoking portion 112, a slope portion 113, and a seating portion 114.

The heating portion 111 protrudes downward from the lower container 110 in such a way as to come into close contact with the heating medium and receives far-infrared emitters 115 therein to emit far-infrared rays when heated. The downward protrusion of the heating portion 111 is circular and has a diameter L corresponding to the diameter of the heating medium. For example, the heating medium has a burner with a diameter of 18 cm, and the diameter L of the downward protrusion of the heating portion 111 is 18 cm. That is, the size of the heating portion 111 may be varied according to the size of the burner.

The smoking portion 112 extends outward from the top periphery of the heating portion 111. A smoke generator is placed on top of the smoking portion 112. The smoke generator does not receive heat directly from the heating medium, but it generates smoke by means of the heat conducted from the heating portion 111. To do this, the lower container 110 is made of a material with high heat conduction, such as stainless steel, aluminum, copper, cast iron, enamel, and the like.

The slope portion 113 is formed to provide a stepped portion between the smoking portion 112 and the seating portion 14. That is, the smoking portion 112 and the seating portion 14 are separated from each other by means of the slope portion 113, and a space in which the smoke generator moves upward is formed by means of the stepped portion. According to another embodiment of the present invention, the slope portion 113 may be omitted, and in this case, the seating portion 114 has an upward and outward slope.

The seating portion 114 extends more outward from the periphery of the smoking portion 112. The upper container 120 is seated on the seating portion 114. According to the embodiment of the present invention, a cooking plate 121 of the upper container 120 has a downward and outward slope, and a portion of the underside of the cooking plate 121 is brought into contact with the seating portion 114, so that the upper container 120 becomes seated on the seating portion 114. According to the embodiment of the present invention, the periphery of the seating portion 114 comes into contact with the inner periphery of a discharge groove 126 of the upper container 120.

The upper container 120 is configured to provide a cooking space in which the dish to be prepared is received and an internal temperature of the dish increases by means of the air heated in the lower container 110. The upper container 120 consists of the cooking plate 121, an exhauster 122, a cap 123, a fastener 124, a wing 125, and the discharge groove 126.

The cooking plate 121 serves to seat the dish to be prepared thereon. The cooking plate 121 has the shape of a circular plate and has the downward and outward slope. This allows materials discharged from the dish to be prepared, such as oils, and the like to be collected to the discharge groove 126 formed on the periphery of the cooking plate 121. According to an embodiment of the present invention, the lower container 110 is made of a material with high heat conduction, such as stainless steel, aluminum, copper, cast iron, enamel, and the like.

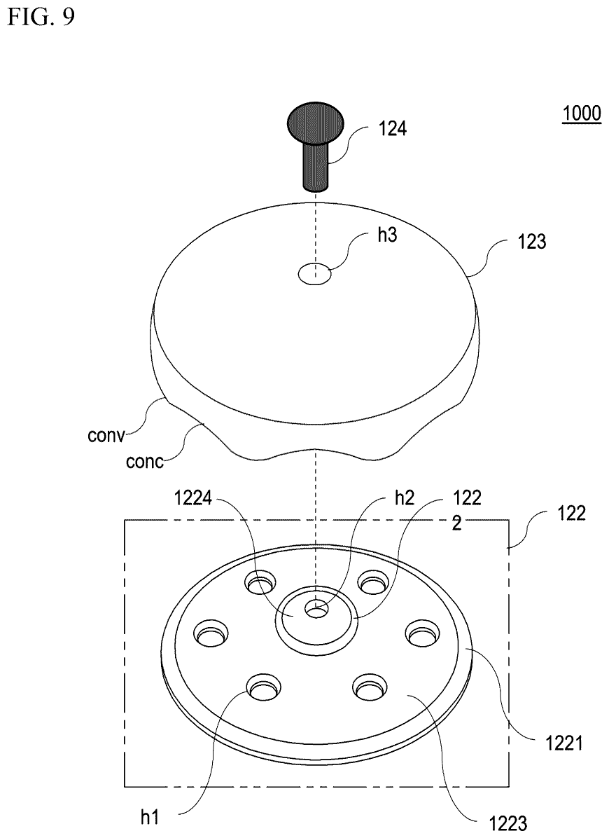

The exhauster 122, the cap 123, and the fastener 124 constitute a heat inlet part 1000. The heat inlet part 1000 is located at the center of the cooking plate 121 and discharges the heated air introduced from the lower container 110 along the surface of the cooking plate 121. For example, the air heated in the lower container 110 enters the upper container 120 through a discharge path formed by the exhauster 122 and the cap 123 and thus generates convection in the upper container 120 to allow the dish to be prepared to be cooked. The fastener 124 serves to fixedly connect the exhauster 122 and the cap 123 to each other. An explanation of the heat inlet part 1000 will be given in detail later with reference to FIGS. 9 to 11.

The wing 125 is located on the outermost portion of the upper container 120, and the periphery of the lid 130 is seated on the wing 125. The wing 125 extends outward from top of the upper container 120 by a given length, and as the wing 125 as a handle is held by a user, the upper container 120 is lifted up and thus separated from the lower container 110. According to another embodiment of the present invention, the wing 125 is provided with handles made of a material with low heat conduction, such as silicone, and the like.

The wing 125 is connected to the discharge groove 126. The discharge groove 126 is located on the periphery of the cooking plate 121 to collect the materials discharged from the dish to be prepared thereto along the downward slope of the cooking plate 121. The discharge groove 126 has one or more discharge holes H adapted to discharge the materials discharged from the dish to be prepared to the outside of the upper container 120.

The lid 130 serves to cover the upper container 120 to prevent the dish to be prepared from being exposed to the outside. The lid 130 has a handle 135 located at the center thereof. The lid 130 is made of reinforced glass. According to an embodiment of the present invention, the lid 130, the upper container 120, and the lower container 110 have the same central axis as each other.

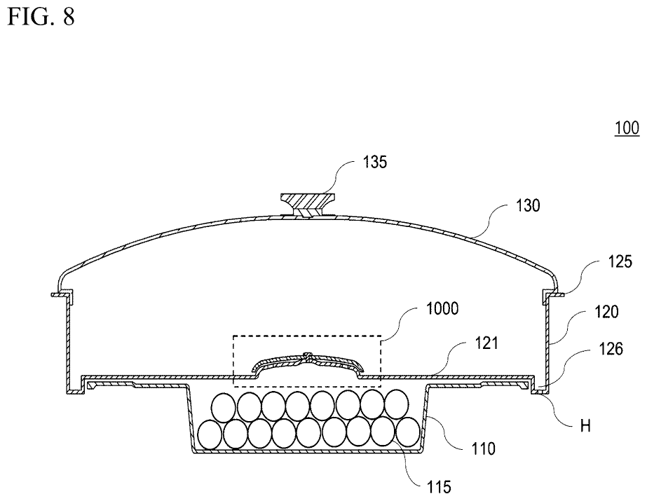

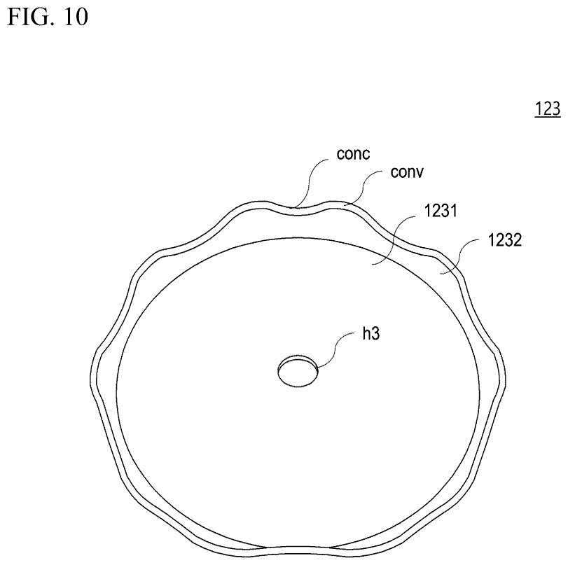

FIG. 8 is a sectional view showing the household cookware of FIG. 2, FIG. 9 is an exploded view showing the heat inlet part of FIG. 8, and FIG. 10 is a bottom view showing the cap of FIG. 9. Referring to FIGS. 8 to 10, the upper container 120 is provided with the heat inlet part 1000.

The heat inlet part 1000 includes the exhauster 122, the cap 123, and the fastener 124. The exhauster 122 includes a plurality of inlet holes h1 into which the air heated in the lower container 110 is introduced. The air heated in the lower container 110 enters the upper container 120 only through the plurality of inlet holes h1.

According to the embodiment of the present invention, the exhauster 122 has the shape of an entirely convex circle. The exhauster 122 consists of a first bent portion 1221, a second bent portion 1222, a first connection portion 1223, and a second connection portion 1224.

The first bent portion 1221 has the shape of a loop surrounding the outer periphery of the exhauster 121. The first bent portion 1221 is bent in a direction where the absolute value of a surface inclination increases as it goes outward. The first bent portion 1221 is bent to form a first stepped portion. The first stepped portion in relation to the cap 123 provides a path along which the air introduced in the exhauster 121 from the lower container 110 is exhausted, and the first stepped portion in relation to the cooking plate 121 prevents oils and other materials from entering the lower container 110.

The second bent portion 1222 has the shape of a loop with a shorter diameter than the first bent portion 1221. The second bent portion 1222 is bent in a direction where the absolute value of a surface inclination increases as it goes outward. The second bent portion 1222 is bent to form a second stepped portion so that a storage space is formed to store the air introduced through the plurality of inlet holes h1. That is, the first bent portion 1221 and the second bent portion 1222 are provided to form two-stage stepped portions.

The first connection portion 1223 serves to connect the first bent portion 1221 and the second bent portion 1222 to each other. The plurality of inlet holes h1 are formed on the first connection portion 1223. The plurality of inlet holes h1 are arranged at given intervals on the first connection portion 1223 in a circumferential direction of the first connection portion 1223. According to the embodiment of the present invention, the first connection portion 1223 has a surface with a given inclination or upward convex shape.

The second connection portion 1224 serves to connect the interior of the second bent portion 1222. The second connection portion 1224 has a first through hole h2 through which the fastener 124 passes. The first through hole h2 is formed at the center of the second connection portion 1224. According to the embodiment of the present invention, the second connection portion 1224 has a surface with a given inclination or upward convex shape.

The cap 123 is provided to form an exhaust path of the heated air, while covering the exhauster 122. The cap 123 consists of a circular plate 1231 and a leg 1232. The circular plate 1231 has a second through hole h3 formed at the center thereof to pass the fastener 124 therethrough. The leg 1232 extends downward from the periphery of the circular plate 1231 in such a way as to surround the first bent portion 1221.

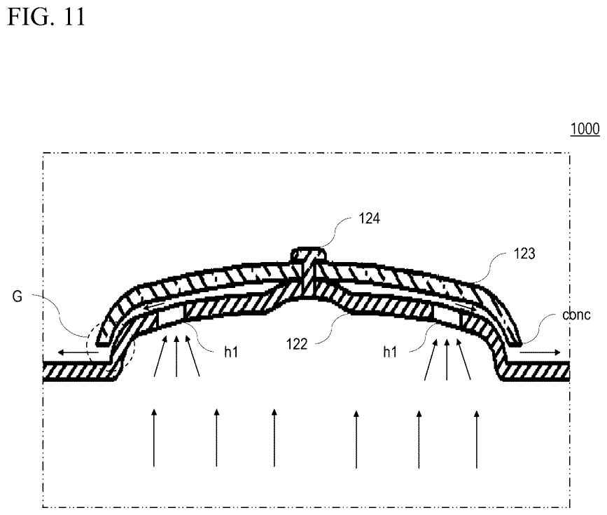

The leg 1232 has a plurality of convex portions conv and a plurality of concave portions conc arranged alternately with one another. According to another embodiment of the present invention, the lower end of the leg 1232 has the shape of a wave. If the leg 1232 is located to surround the first bent portion 1221, a gap (Reference symbol G of FIG. 11) is generated between the concave portions conc and the exhauster 122. As a result, the exhaust path along which heated air is exhausted to the gap G is formed.

The fastener 124 serves to connect the centers of the exhauster 122 and the cap 123 to each other. The fastener 124 passes through the first through hole h2 of the exhauster 122 and the second through hole h3 of the cap 123 and is then fastened to fix the exhauster 122 and the cap 123 to each other. For example, the fastener 124 fixes the exhauster 122 and the cap 123 to each other by means of bolt-nut coupling. For another example, the fastener 124 fixes the exhauster 122 and the cap 123 to each other by means of rivet coupling.

According to the embodiment of the present invention, when the exhauster 122 and the cap 123 are coupled to each other, the second bent portion 1222 provides a gap space between the exhauster 122 and the cap 123. The circular plate 1231 is flat or has the same inclination as the first connection portion 1223 and is thus spaced apart from the first connection portion 1223 by means of the upward convex second bent portion 1222. The heated air passing through the plurality of inlet holes h1 is stored in the gap space between the exhauster 122 and the cap 123, and if it is over a given pressure, it is exhausted along the exhaust path.

FIG. 11 is a sectional view showing the flow of air through the heat inlet part of FIG. 8. Referring to FIG. 11, the heated air in the lower container 110 moves upward and thus enters the upper container 120 through the heat inlet part 1000.

According to the embodiment of the present invention, the heated air passes through the plurality of inlet holes h1 and is then stored in the gap space between the exhauster 122 and the cap 123. The exhauster 122 provides the gap space by means of the second bent portion 1222 when coupled to the cap 123, and the heated air passes through the plurality of inlet holes h1 and is thus stored in the gap space.

The heated air is emitted to the cooking plate 121 through the exhaust path. As the leg 1232 surrounds the first bent portion 1221, the gap G is generated between the concave portions conc of the leg 1232 and the exhauster 122, and the heated air is exhausted through the gap G.

According to the embodiment of the present invention, as the heated air is continuously introduced, a pressure in the gap space is relatively higher than a pressure in the internal space of the upper container 120. If the heated air has a pressure over a given pressure, in this case, it is exhausted to the internal space of the upper container 120 from the gap space. In this case, the gap G is relatively narrower than the gap space between the exhauster 122 and the cap 123, and the flow rate of the air exhausted through the gap G becomes fast.

The heated air introduced into the upper container 120 through the heat inlet part 1000 moves toward the surface of the cooking plate 121. That is, the introduced air generates convection in the interior of the upper container 120 and is circulated in the interior of the upper container 120. As a result, the dish to be prepared is indirectly cooked quickly and evenly.

According to the embodiment of the present invention, if the smoke generator is located in the smoking portion 112 of the lower container 110, the smoke generated from the smoke generator is introduced into the upper container 120 through the plurality of inlet holes h1 and the gap G. As a result, a smoky flavor is applied to the dish to be prepared so that a smoked dish may be prepared at home simply and conveniently.

According to the embodiment of the present invention, if the far-infrared emitters 115 are located on the heating portion 111 of the lower container 110, the far-infrared rays emitted from the far-infrared emitters 115 are introduced into the upper container 120 through the plurality of inlet holes h1 and the gap G. The smoke of the dish to be prepared is removed by means of the far-infrared emitters 115, and the taste and flavor of the dish are improved, while the high-fat oils of the dish are being discharged.

Although specific embodiments have been illustrated and described herein, it will be appreciated by those of ordinary skill in the art that any specific arrangement of software, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. Household cookware comprising:
a lower container directly heated by a heating medium located therebelow;
an upper container seated on top of the lower container in such a way as to receive a dish to be prepared therein to provide a cooking space in which an internal temperature of the dish to be prepared increases by means of air heated in the lower container; and
a lid for covering the upper container so that the dish to be prepared is not exposed to the outside,
wherein the upper container comprises:
a cooking plate on which the dish to be prepared is placed;
a heat inlet part located at the center of the cooking plate in such a way as to emit, along the surface of the cooking plate, the heated air that flows in from the lower container;
a discharge groove located at the periphery of the cooking plate in such a way as to collect materials discharged from the dish to be prepared along a downward slope of the cooking plate; and
a wing connected to the discharge groove in such a way as to seat the periphery of the lid thereon to fix the lid thereto.

2. The household cookware according to claim 1, wherein the heat inlet part comprises:
an exhauster having a plurality of inlet holes into which the air heated in the lower container is introduced;
a cap provided to form an exhaust path of the heated air, while covering the exhauster; and
a fastener for connecting centers of the exhauster and the cap.

3. The household cookware according to claim 2, wherein the exhauster comprises:
a first bent portion having the shape of a loop surrounding the outer periphery of the exhauster to provide a first stepped portion; a second bent portion having the shape of a loop with a shorter diameter than the first bent portion to provide a second stepped portion;
a first connection portion connecting the first bent portion and the second bent portion to each other and having the plurality of inlet holes thereon; and
a second connection portion connecting an interior of the second bent portion and having a first through hole at the center thereof to pass the fastener therethrough.

4. The household cookware according to claim 3, wherein the cap comprises:
a circular plate having a second through hole at the center thereof to pass the fastener therethrough; and
a leg extending downward from the periphery of the circular plate in such a way as to surround the first bent portion.

5. The household cookware according to claim 4, wherein the leg has a plurality of convex portions and a plurality of concave portions arranged alternately with one another, and the exhaust path is formed by means of a gap between the concave portions and the exhauster.

6. The household cookware according to claim 1, wherein the discharge groove has discharge holes adapted to discharge the materials discharged from the dish to be prepared to the outside of the upper container.

7. The household cookware according to claim 1, wherein the lower container comprises:
a heating portion protruding downward therefrom in such a way as to come into contact with the heating medium and receiving far-infrared emitters therein to emit far-infrared rays when heated;
a smoking portion extending outward from top of the heating portion in such a way as to place a smoking generator on top thereof; and
a seating portion extending outward from the periphery of the smoking portion in such a way as to come into contact with a portion of the underside of the upper container to seat the upper container thereon.

8. The household cookware according to claim 7, wherein the lower container further comprises a slope portion between the smoking portion and the seating portion to provide a stepped portion therebetween.
